(19) United States
(12) Patent Application Publication
(10) Pub. No.: US 2017/0051650 A1
(43) Pub. Date: Feb. 23, 2017

(54) PM DETECTION DEVICE FOR INTERNAL COMBUSTION ENGINE

(71) Applicant: DENSO CORPORATION, Kariya-city, Aichi-pref. (JP)

(72) Inventor: Shingo NAKATA, Kariya-city (JP)

(21) Appl. No.: 15/119,428

(22) PCT Filed: Feb. 24, 2015
(86) PCT No.: PCT/JP2015/000915

§ 371 Date: Aug. 17, 2016

(30) Foreign Application Priority Data
Mar. 17, 2014 (JP) 2014-53741

(51) Int. Cl. F01N 9/00; F01N 11/00; G01N 15/06; F01N 3/021

(52) U.S. Cl. CPC F01N 9/002; F01N 3/021; F01N 11/00; G01N 15/0618; G01N 15/0656; F01N 2560/05; F01N 2900/08; F01N 2900/1606

(57) ABSTRACT

A PM detection device for an internal combustion engine includes a PM sensor outputting a signal in response to a resistance between a plurality of electrodes provided to a detection portion to which a particulate matter emitted from an internal combustion engine are attached, and a PM detection portion computing a PM attachment amount, which is an amount of a PM attached to the detection portion of the PM sensor, based on an output signal of the PM sensor by using a relation between the output signal of the PM sensor and the PM attachment amount. The PM detection portion corrects the PM attachment amount in response to an operating condition of the internal combustion engine when computing the PM attachment amount based on the output signal of the PM sensor.

### CROSS REFERENCE TO RELATED APPLICATION

This application is based on Japanese Patent Application No. 2014-53741 filed on Mar. 17, 2014, the disclosure of which is incorporated herein by reference.

### TECHNICAL FIELD

The present disclosure relates to a PM detection device of an internal combustion engine having a PM sensor that detects a particulate matter (PM) emitted from the internal combustion engine.

### BACKGROUND ART

In recent years, the PM emitted not only from diesel engines but from in-cylinder injection gasoline engines attracts attention. PM regulations are being increased. Especially in the areas where severe regulations are being increased, not only emitted weight of PM but also the number of emitted particles of PM is subject to the regulations. Because of the increased regulations, mounting of filters in gasoline engines in addition to diesel engines is being considered to trap the PM emitted from the engines.

When such a PM trapping filter is mounted, detection of failure of the filter is also necessary. High accuracy is necessary to detect failure of the filter in view of the increased PM regulations.

Patent Literature 1 (JP2009-144577A) describes an art of detecting failure of a PM trapping filter. The art includes a PM sensor located downstream of the PM trapping filter. The PM sensor has an insulating layer to which PM is attached and multiple electrodes provided to the insulating layer to measure a resistance between the multiple electrodes or an indicator correlating to the resistance as information about a deposition amount indicating a PM attachment amount. When the measured resistance or the indicator correlating to the resistance exceeds a failure determination threshold, it is determined that the PM attachment amount exceeds a predetermined amount, and it is thus determined that the filter fails.

When a particle size distribution of the PM attached to the PM sensor is constant, the resistance between the electrodes of the PM sensor and the PM attachment amount indicate a certain correlation. When the particle size distribution of the PM attached to the PM sensor changes, the relation between the resistance between the electrodes of the PM sensor and the PM attachment amount changes. Therefore, when an engine operating condition (for example, air-fuel ratio) changes and the particle size distribution of the PM emitted from the engine changes, the particle size distribution of the PM attached to the PM sensor changes and the relation between the resistance between the electrodes of the PM sensor and the PM attachment amount changes.

However, the effect of the change in the particle size distribution of PM due to such a change in the engine operating condition is not taken into consideration at all in the art of Patent Literature 1. The PM attachment amount of the PM sensor may not be accurately determined under the effect of the change in the PM particle size distribution due to the change in the engine operating condition. The accuracy of a PM detection by the PM sensor is reduced.

### PRIOR ART LITERATURES

### Patent Literature

Patent Literature 1: JP2009-144577A

### SUMMARY OF INVENTION

It is an object of the present disclosure is to provide a PM detection device of an internal combustion engine to accurately determine a PM attachment amount of a PM sensor regardless of an operating condition of the internal combustion engine and to improve an accuracy of a PM detection by the PM sensor.

According to an aspect of the present disclosure, the PM detection device of the internal combustion engine includes a PM sensor outputting a signal in response to a resistance between a plurality of electrodes provided to a detection portion to which a particulate matter emitted from the internal combustion engine are attached, and a PM detection portion computing a PM attachment amount, which is an amount of a PM attached to the detection portion of the PM sensor, based on an output signal of the PM sensor by using a relation between the output signal of the PM sensor and the PM attachment amount. The PM detection portion corrects the PM attachment amount in response to an operating condition of the internal combustion engine when computing the PM attachment amount based on the output signal of the PM sensor.

A particle size distribution of the PM emitted from the internal combustion engine changes in response to the operating condition of the internal combustion engine. The particle size distribution of the PM attached to the PM sensor accordingly changes. This changes the relation between the resistance between the electrodes of the PM sensor and the PM attachment amount (the relation between the output signal of the PM sensor and the PM attachment amount).

With attention to such a characteristic, according to the present disclosure, when computing the PM attachment amount based on the output signal of the PM sensor, the PM detection portion corrects the PM attachment amount in response to the operating condition of the internal combustion engine. The PM detection portion thus accurately acquires the PM attachment amount in response to the change in the relation between the output signal of the PM sensor and the PM attachment amount when the particle size distribution of the PM attached to the PM sensor changes in response to the operating condition of the internal combustion engine. As a result, the PM detection portion can accurately determine the PM attachment amount of the PM sensor regardless of the operating condition of the internal combustion engine, and improve the accuracy of a PM detection by the PM sensor.

### BRIEF DESCRIPTION OF DRAWINGS

The above and other objects, features and advantages of the present disclosure will become more apparent from the following detailed description made with reference to the accompanying drawings. In the drawings:

FIG. 1 illustrates an overall configuration of an engine control system in a first embodiment of the present disclosure;

FIG. 2 illustrates a relation among air-fuel ratios, PM emission amount, and a particle size distribution of PM;

FIG. 3 illustrates a flowchart of a PM-attachment-amount estimation routine of the first embodiment;

FIG. 4 illustrates a flowchart of a PM-attachment-amount estimation routine of a second embodiment;

FIG. 5 illustrates a relation among an in-cylinder wet amounts, PM emission amount, and PM particle size distribution; and

FIG. 6 illustrates a flowchart of a PM-attachment-amount estimation routine of a third embodiment.

### DESCRIPTION OF EMBODIMENTS

### First Embodiment

Embodiments of the present disclosure will be described hereafter referring to drawings.

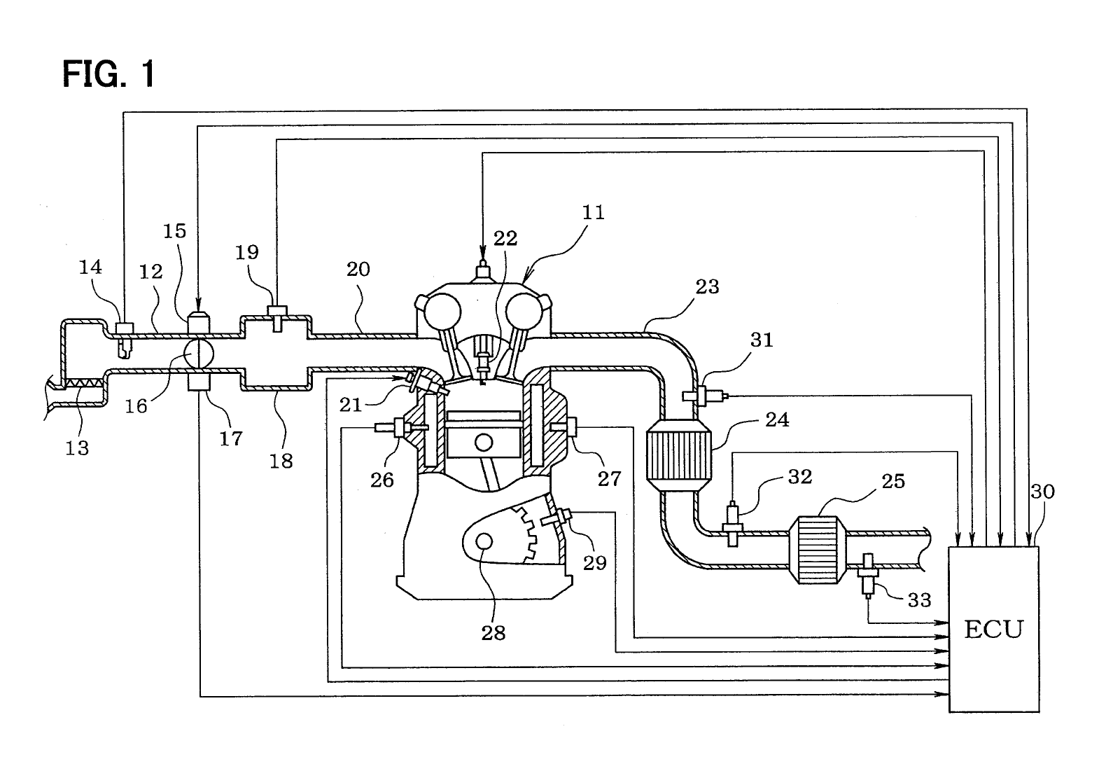

A first embodiment of the present disclosure is described based on FIGS. 1 to 3.

First, an overall configuration of an engine control system is explained based on FIG. 1.

An engine 11, an in-cylinder injection internal combustion engine, directly injects gasoline into a cylinder as a fuel. An air cleaner 13 is provided to the most upstream of an intake tube 12 of the engine 11. An airflow meter 14 is provided downstream of the air cleaner 13 to detect an intake air amount. A throttle valve 16 whose position is adjusted by a motor 15 and a throttle position sensor 17 that detects a position of the throttle valve 16 are provided downstream of the airflow meter 14. In the case, the position of the throttle valve 16 is called a throttle position.

A surge tank 18 is provided downstream of the throttle valve 16. An intake pipe pressure sensor 19 is provided to the surge tank 18 to detect an intake pipe pressure. An intake manifold 20 is provided to the surge tank 18 to introduce air into each cylinder of the engine 11. A fuel injection valve 21 is attached to each cylinder of the engine 11 to directly inject gasoline fuel into each cylinder. A spark plug 22 is attached to a cylinder head of each cylinder of the engine 11. The spark plug 22 of each cylinder sparks to ignite fuel-air mixture in each cylinder.

A catalyst 24 such as a three-way catalyst is provided to an exhaust pipe 23 of the engine 11 to purify an exhaust gas. Exhaust gas sensors 31 and 32 are respectively provided upstream and downstream of the catalyst 24 to detect the air-fuel ratio or rich or lean of the exhaust gas. In the case, the exhaust gas sensors 31 and 32 include an air-fuel ratio sensor and an oxygen sensor. A gasoline particulate filter (GPF) 25 is provided downstream of the catalyst 24 of the exhaust pipe 23 of the engine 11 as a filter that traps a particulate matter (PM) emitted from the engine 11.

A PM sensor 33 is provided downstream of the GPF 25 to detect the PM emitted from the engine 11. In the present embodiment, the above PM passes through the GPF 25. The PM sensor 33 has a detection portion (unshown) having an insulation material to which PM is attached and multiple electrodes (unshown) provided to the detection portion to output signals in response to a resistance between the multiple electrodes. The PM sensor 33 outputs a signal that changes due to a change in the resistance between the electrodes in response to an amount of the PM attached to the detection portion. In the case, the amount of the PM includes weight and the particle number of PM, and the signal indicates voltage or current.

A cooling-water temperature sensor 26 that detects cooling water temperature and a knock sensor 27 that detects knocking are attached to the cylinder block of the engine 11. A crank angle sensor 29 is attached to the periphery of a crankshaft 28 to output a pulse signal each time the crankshaft 28 rotates at a predetermined crank angle. Crank angles and engine rotational speeds are detected based on output signals of the crank angle sensor 29.

The outputs of the various sensors are inputted into an electronic control unit (ECU) 30. The ECU 30 mainly includes a microcomputer, and executes various engine control programs stored in a storage medium, a built-in ROM, to control fuel injection, ignition timing, and a throttle position (intake air amount) in response to the engine operating condition.

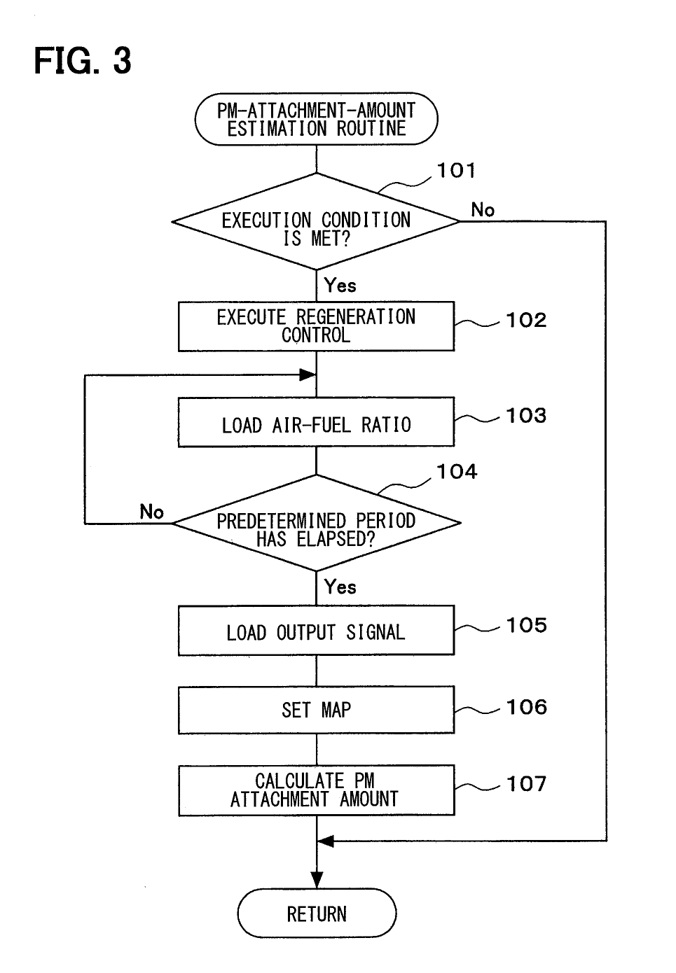

The ECU 30 executes a PM-attachment-amount estimation routine of FIG. 3 to compute a PM attachment amount of the PM sensor 33 based on the output signal of the PM sensor 33 by use of the relation between the output signal of the PM sensor 33 and the amount of the PM attached to the detection portion of the PM sensor 33. The amount of the PM attached to the detection portion of the PM sensor 33 is hereinafter called a PM attachment amount. Specifically, a map of the PM attachment amount is previously stored. The PM attachment amount is computed in response to the output signal of the PM sensor 33 with reference to the map of the PM attachment amount. In the case, the map defines the relation between the output signal of the PM sensor 33 and the PM attachment amount.

The ECU 30 executes failure diagnosis of the GPF 25 based on the PM attachment amount of the PM sensor 33 after computing the PM attachment amount of the PM sensor 33. The failure diagnosis of the GPF 25 determines whether the PM attachment amount of the PM sensor 33 exceeds a failure determination value. When the PM attachment amount of the PM sensor 33 exceeds the failure determination value, it is determined that the GPF 25 fails.

When the particle size distribution of the PM attached to the PM sensor 33 is constant, the resistance between the electrodes of the PM sensor 33 and the PM attachment amount indicate a certain correlation. When the particle size distribution of the PM attached to the PM sensor 33 changes, the relation between the resistance between the electrodes of the PM sensor 33 and the PM attachment amount changes. Therefore, when the operating condition of the engine 11 changes and the particle size distribution of the PM emitted from the engine 11 changes, the particle size distribution of the PM attached to the PM sensor 33 changes. The relation between the resistance between the electrodes of the PM sensor 33 and the PM attachment amount (that is, the relation between the output signal of the PM sensor 33 and the PM attachment amount) accordingly changes.

The ECU 30 executes the PM-attachment-amount estimation routine of FIG. 3 to correct the PM attachment amount in response to the operating condition of the engine 11 when computing the PM attachment amount based on the output signal of the PM sensor 33. In the present embodiment, the ECU 30 and the PM sensor 33 correspond to a PM detection device of an internal combustion engine.

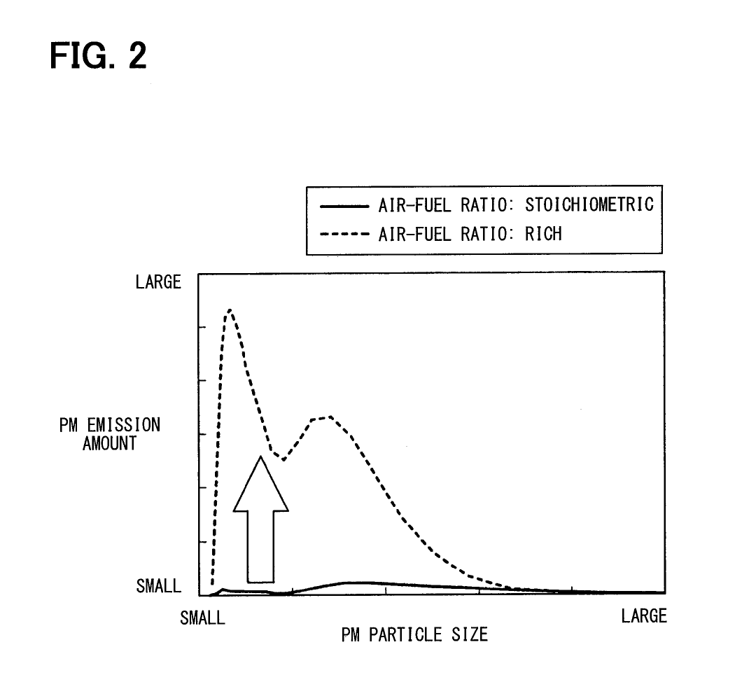

As in FIG. 2, the particle size distribution of the PM emitted from the engine 11 changes in response to the air-fuel ratio of the engine 11. The particle size distribution of the PM attached to the PM sensor 33 accordingly changes. This changes the relation between the resistance between the electrodes of the PM sensor 33 and the PM attachment amount (the relation between the output signal of the PM sensor 33 and the PM attachment amount).

With attention to such a characteristic, the first embodiment uses the air-fuel ratio of the engine 11 as the operating condition of the engine 11 to correct the PM attachment amount in response to the operating condition of the engine 11. That is, when computing the PM attachment amount based on the output signal of the PM sensor 33, the PM attachment amount is corrected in response to the air-fuel ratio of the engine 11. Specifically, the map of the PM attachment amount is changed in response to the air-fuel ratio of the engine 11 to correct the PM attachment amount in response to the air-fuel ratio of the engine 11. The particle size distribution of the PM attached to the PM sensor 33 accordingly changes in response to the air-fuel ratio of the engine 11. Thus, the PM attachment amount is corrected and accurately determined in response to the change in the relation between the output signal of the PM sensor 33 and the PM attachment amount.

The PM-attachment-amount estimation routine of FIG. 3 executed by the ECU 30 in the first embodiment is hereinafter explained.

The PM-attachment-amount estimation routine shown in FIG. 3 is repeatedly executed at a given period during the power-on state of the ECU 30 to serve as a PM detection portion.

When the present routine is activated, the ECU 30 first determines whether an execution condition that is predetermined is met at 101, for example, whether the condition that permits avoidance of water damage to the PM sensor 33 is met. The water damage to the PM sensor 33 is in the state that condensation water adheres to the PM sensor 33. The condition that permits avoidance of water damage to the PM sensor 33 is that the exhaust temperature of the engine 11 or the temperature of the exhaust pipe 23 is a predetermined temperature or more or that the elapsed time or traveled time after start of the engine 11 is a predetermined time or more.

The ECU 30 ends the present routine at 101 without executing the processes at or after 102 when determining that the execution condition is not met.

When determining that the execution condition is met at 101, the ECU 30 proceeds to 102 to execute a regeneration control that removes the PM attached to the detection portion of the PM sensor 33. The regeneration control burns and removes the PM attached to the detection portion of the PM sensor 33, for example, by heating the detection portion of the PM sensor 33 with a heater or by raising the exhaust gas temperature to heat the detection portion of the PM sensor 33.

After termination of the regeneration control, the ECU 30 proceeds to 103 to load the air-fuel ratio of the engine 11. In the case, the air-fuel ratio of the engine 11 is a target air fuel ratio or an air-fuel ratio detected by the exhaust gas sensor 31.

Then, the ECU 30 proceeds to 104 to determine whether a predetermined period has elapsed after termination of the regeneration control, for example, based on whether the elapsed time after termination of the regeneration control is a prescribed time or more or on whether a traveled distance or integration of injection after termination of the regeneration control is a predetermined period or more.

When determining that the predetermined period does not have elapsed after termination of the regeneration control at 104, the ECU 30 returns to 103 to repeatedly load the air-fuel ratio of the engine 11.

Then, when determining that the predetermined period has elapsed after termination of the regeneration control at 104, the ECU 30 proceeds to 105 to load the output signal of the PM sensor 33.

Then, the ECU 30 proceeds to 106 to set the map of the PM attachment amount in response to the air-fuel ratio during the predetermined period. In the case, the air-fuel ratio in the predetermined period may be an average of the air-fuel ratios during the predetermined period. Specifically, the ECU 30 previously creates maps of the PM attachment amounts for every air-fuel ratios based on examination data and design data and stores the maps to the ROM of the ECU 30, and selects the map of the PM attachment amount corresponding to the air-fuel ratio during the predetermined period from the multiple maps of PM attachment amounts.

Then, the ECU 30 proceeds to 107, and calculates or estimates the PM attachment amount in response to the output signal of the PM sensor 33 with reference to the map of the PM attachment amount.

Thus, when computing the PM attachment amount based on the output signal of the PM sensor 33, the ECU 30 changes the map of the PM attachment amount in response to the air-fuel ratio of the engine 11 to correct the PM attachment amount in response to the air-fuel ratio of the engine 11.

In the first embodiment, when computing the PM attachment amount based on the output signal of the PM sensor 33, the ECU 30 corrects the PM attachment amount in response to the air-fuel ratio of the engine 11. The ECU 30 thus accurately acquires the PM attachment amount in response to the change in the relation between the output signal of the PM sensor 33 and the PM attachment amount when the particle size distribution of the PM attached to the PM sensor 33 changes in response to the air-fuel ratio of the engine 11. As a result, the ECU 30 can accurately determine the PM attachment amount of the PM sensor 33 regardless of the air-fuel ratio of the engine 11, and improve the accuracy of a PM detection by the PM sensor 33. In the case, the PM attachment amount includes the weight and the number of PM particles.

In the first embodiment, the ECU 30 corrects the PM attachment amount in response to the air-fuel ratio of the engine 11 by changing the map of the PM attachment amount in response to the air-fuel ratio of the engine 11. The PM attachment amount can be thus corrected through the easy way of changing the map of the PM attachment amount in response to the air-fuel ratio of the engine 11, and the computational a load of the ECU 30 can be reduced.

### Second Embodiment

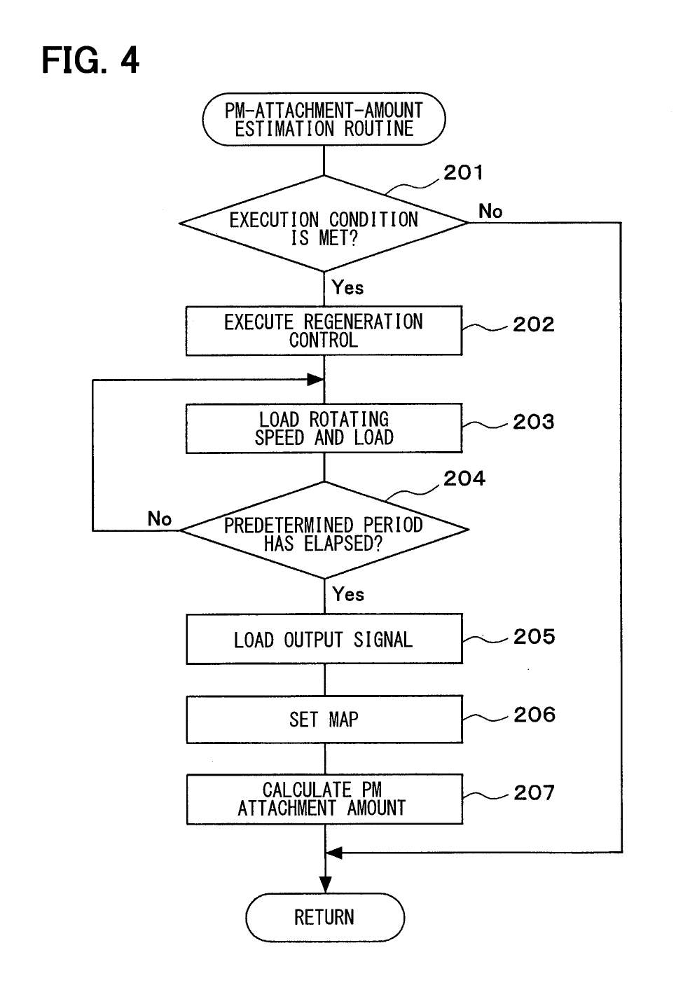

Next, a second embodiment of the present disclosure is described using FIG. 4. Description about the substantially same portions as the first embodiment is omitted or simplified. Different portions from the first embodiment are mainly explained.

The particle size distribution of the PM emitted from the engine 11 changes in response to the rotating speed or a load of the engine 11 or both the rotating speed and the load. The particle size distribution of the PM attached to the PM sensor 33 accordingly changes. This changes the relation between the resistance between the electrodes of the PM sensor 33 and the PM attachment amount (the relation between the output signal of the PM sensor 33 and the PM attachment amount).

With attention to such a characteristic, the second embodiment uses the rotating speed and the load of the engine 11 as the operating conditions of the engine 11 when the ECU 30 executes a PM-attachment-amount estimation routine of FIG. 4 to correct the PM attachment amount in response to the operating conditions of the engine 11. That is, when the PM attachment amount is computed based on the output signal of the PM sensor 33, the PM attachment amount is corrected in response to the rotating speed and the load of the engine 11. Specifically, the PM attachment amount is corrected in response to the rotating speed and the load of the engine 11 by changing the map of the PM attachment amount in response to the rotating speed and the load of the engine 11. Thus, the particle size distribution of the PM attached to the PM sensor 33 changes in response to the rotating speed and the load of the engine 11 to change the relation between the output signal of the PM sensor 33 and the PM attachment amount. In response to the change in the relation, the PM attachment amount is corrected and accurately acquired.

In the PM-attachment-amount estimation routine of FIG. 4, the ECU 30 first determines whether an execution condition that is predetermined is met at 201.

When determining that the execution condition is met at 201, the ECU 30 proceeds to 202 to execute a regeneration control that removes the PM attached to the detection portion of the PM sensor 33. After termination of the regeneration control, the ECU 30 proceeds to 203 and loads the rotating speed and the load of the engine 11. In the case, the load includes an intake air amount or intake air pressure.

The ECU 30 then proceeds to 204 and determines whether the predetermined period has elapsed since termination of the regeneration control. When determining that the predetermined period does not have elapsed since termination of the regeneration control at 204, the ECU 30 returns to 203 to repeatedly load the rotating speed and the load of the engine 11.

Then, when determining that the predetermined period has elapsed since termination of the regeneration control at 204, the ECU 30 proceeds to 205 to load the output signal of the PM sensor 33.

Then, the ECU 30 proceeds to 206 and sets the map of the PM attachment amount in response to the rotating speed and load during a predetermined period (for example, an average value of the rotating speeds and an average value of the loads in the predetermined period). Specifically, the ECU 30 previously creates the map of the PM attachment amount for each rotating speed and each load based on examination data and design data to store the maps to the ROM of the ECU 30. The map of the PM attachment amount corresponding to the rotating speed and load during a current predetermined period is selected from the multiple maps of the PM attachment amounts.

The ECU 30 then proceeds to 207, and computes or estimates the PM attachment amount in response to the output signal of the PM sensor 33 with reference to the map of the PM attachment amount.

Thus, when computing the PM attachment amount based on the output signal of the PM sensor 33, the ECU 30 corrects the PM attachment amount in response to the rotating speed and the load of the engine 11 by changing the map of the PM attachment amount in response to the rotating speed and the load of the engine 11.

In the second embodiment, when computing the PM attachment amount based on the output signal of the PM sensor 33, the ECU 30 corrects the PM attachment amount in response to the rotating speed and the load of the engine 11. The particle size distribution of the PM attached to the PM sensor 33 thus changes in response to the rotating speed and the load of the engine 11. Then, the PM attachment amount can be corrected and accurately acquired in response to the change in the relation between the output signal of the PM sensor 33 and the PM attachment amount. As a result, the PM attachment amount of the PM sensor 33 can be accurately determined regardless of the rotating speed and the load of the engine 11. The accuracy of the PM detection by the PM sensor 33 can be accordingly improved.

In the second embodiment, the PM attachment amount is corrected in response to both the rotating speed and the load of the engine 11, but this is not limiting. The PM attachment amount may be corrected in response to one of the rotating speed and the load of the engine 11. For example, the PM attachment amount is corrected in response to the rotating speed of the engine 11 in a range or system where the PM particle size distribution is affected by the rotating speed of the engine 11. The PM attachment amount is corrected in response to the load of the engine 11 in a range or system where the PM particle size distribution is affected by the load of the engine 11.

### Third Embodiment

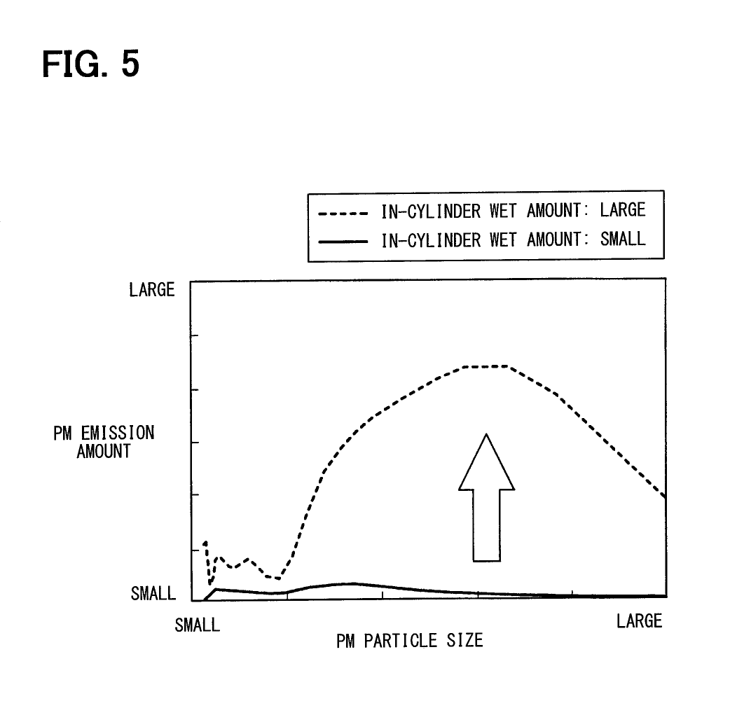

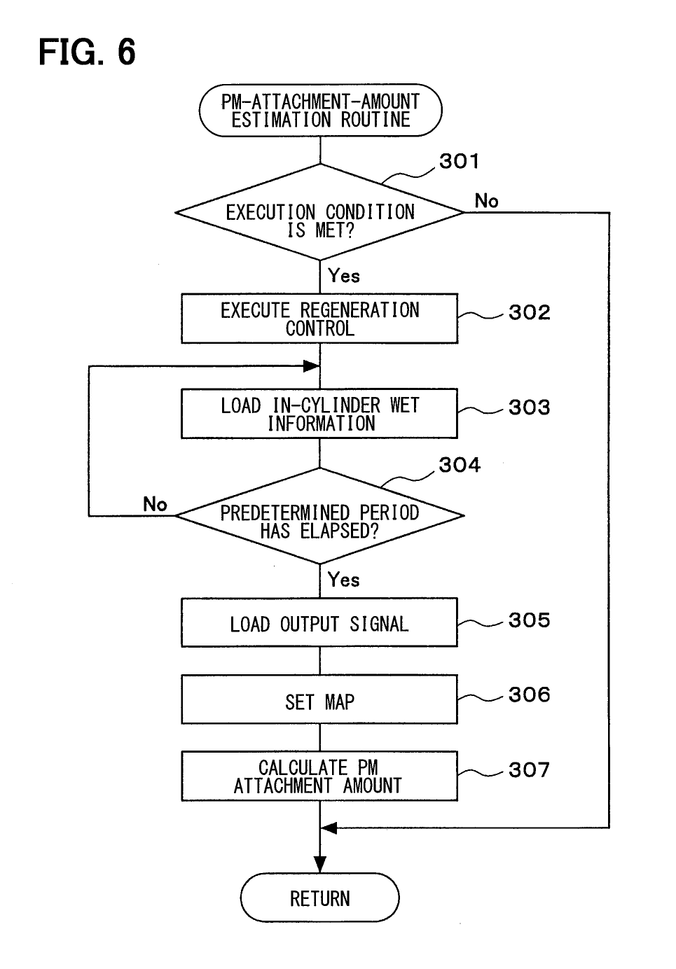

Next, a third embodiment of the present disclosure is described using FIGS. 5 and 6. Explanation about the substantially same portions as the first embodiment is omitted or simplified. Different portions from the first embodiment are mainly explained.

As in FIG. 5, in response to an in-cylinder wet amount, which is an amount of the fuel attached within a cylinder of the engine 11 (for example, an amount of the fuel attached to the piston upper surface and cylinder inner wall), the particle size distribution of the PM emitted from the engine 11 changes, and the particle size distribution of the PM attached to the PM sensor 33 changes accordingly. This changes the relation between the resistance between the electrodes of the PM sensor 33 and the PM attachment amount (the relation between the output signal of the PM sensor 33 and the PM attachment amount).

With attention to such a characteristic, in the third embodiment, the ECU 30 executes a PM-attachment-amount estimation routine of FIG. 6 to use in-cylinder wet information of the engine 11 (parameters having correlation with the in-cylinder wet amount) as the operating condition of the engine 11 when the PM attachment amount is corrected in response to the operating condition of the engine 11. That is, when the PM attachment amount is computed based on the output signal of the PM sensor 33, the PM attachment amount is corrected in response to the in-cylinder wet information of the engine 11. Specifically, the PM attachment amount is corrected in response to the in-cylinder wet information of the engine 11 by changing the map of the PM attachment amount in response to the in-cylinder wet information of the engine 11. Thus, the particle size distribution of the PM attached to the PM sensor 33 changes in response to the in-cylinder wet amount of the engine 11 to change the relation between the output signal of the PM sensor 33 and the PM attachment amount. The PM attachment amount is accordingly corrected and accurately acquired.

In the PM-attachment-amount estimation routine of FIG. 6, the ECU 30 first determines whether an execution condition that is predetermined is met at 301.

When determining that the execution condition is met at 301, the ECU 30 proceeds to 302 to execute a regeneration control that removes the PM attached to the detection portion of the PM sensor 33. After termination of the regeneration control, the ECU 30 proceeds to 303 and loads at least one of cooling water temperature, fuel injection timing, or the number of split injections of the engine 11 as the in-cylinder wet information of the engine 11. In this case, the ECU 30 may load cooling water temperature, fuel injection timing, or the number of split injections of the engine 11 or any combination thereof as the in-cylinder wet information of the engine 11.

The in-cylinder wet amount changes in response to the cooling water temperature of the engine 11. The in-cylinder wet amount changes in response to the fuel injection timing of the engine 11. In the split injections to split required injection fuel of the engine 11 into multiple injections and inject the fuel, the in-cylinder wet amount changes in response to the number of the split injections. Therefore, the cooling water temperature, fuel injection timing, and the number of the split injections are each a parameter that correlates to the in-cylinder wet amount.

The ECU 30 then proceeds to 304 and determines whether a predetermined period has elapsed since termination of the regeneration control. When determining that the predetermined period does not have elapsed since termination of the regeneration control at 304, the ECU 30 returns to 303 and repeatedly loads the in-cylinder wet information of the engine 11.

Then, when determining that the predetermined period has elapsed since termination of the regeneration control at 304, the ECU 30 proceeds to 305 and loads the output signal of the PM sensor 33.

Then, the ECU 30 proceeds to 306 and sets the map of the PM attachment amount in response to the in-cylinder wet information during a predetermined period (for example, an average value of the in-cylinder wet information during the predetermined period). Specifically, the ECU 30 previously creates the map of the PM attachment amount for each in-cylinder wet information on each cylinder based on examination data and design data and stores the maps to the ROM of the ECU 30. The map of the PM attachment amount corresponding to the in-cylinder wet information during the current predetermined period is selected from the multiple maps of the PM attachment amounts.

Then, the ECU 30 proceeds to 307, and computes or estimates the PM attachment amount in reference to the output signal of the PM sensor 33 with reference to the map of PM attachment amount.

Thus, when computing the PM attachment amount based on the output signal of the PM sensor 33, the ECU 30 corrects the PM attachment amount in response to the in-cylinder wet information of the engine 11 by changing the map of the PM attachment amount in response to the in-cylinder wet information of the engine 11.

In the third embodiment, when computing the PM attachment amount based on the output signal of the PM sensor 33, the PM attachment amount is corrected in response to the in-cylinder wet information of the engine 11 (parameters that correlates to the in-cylinder wet amount). Thus, the particle size distribution of the PM attached to the PM sensor 33 changes in response to the in-cylinder wet amount of the engine 11 to change the relation between the output signal of the PM sensor 33 and the PM attachment amount. The PM attachment amount can be accordingly corrected and accurately acquired. As a result, the PM attachment amount of the PM sensor 33 can be accurately determined regardless of the in-cylinder wet amount of the engine 11, and the accuracy of the PM detection by the PM sensor 33 can be improved.

The third embodiment uses at least one of cooling water temperature, fuel injection timing, or the number of split injections of the engine 11 as the in-cylinder wet information of the engine 11, but this is not limiting. Other parameters correlating to the in-cylinder wet amount may be used.

In the first to third embodiments, the PM attachment amount is corrected in response to the operating condition of the engine 11 by changing the map of the PM attachment amount in response to the operating condition of the engine 11 (air-fuel ratio, rotating speed and load, in-cylinder wet information), but this is not limiting. For example, when the PM attachment amount is computed in response to the output signal of the PM sensor 33 by use of an equation for the PM attachment amount (equation that defines the relation between the output signal of the PM sensor 33 and the PM attachment amount), the PM attachment amount may be corrected in response to the operating condition of the engine 11 by changing the equation for the PM attachment amount in response to the operating condition of the engine 11. Alternatively, by use of a basic map or basic equation of the PM attachment amount (map or equation that defines the relation between the output signal of the PM sensor 33 and the PM attachment amount at a basic operating condition of the engine 11), the PM attachment amount is computed in response to the output signal of the PM sensor 33. After that, the computed value of the PM attachment amount may be corrected in response to the operating condition of the engine 11.

By appropriately combining the first to third embodiments, the PM attachment amount may be corrected in response to two or more of the air-fuel ratio, rotating speed and load, or in-cylinder wet information of the engine 11. In this case, the PM attachment amount may be corrected in response to the air-fuel ratio and the rotating speed and the load, or the rotating speed and the load and the in-cylinder wet information, or the air-fuel ratio and the in-cylinder wet information, or the air-fuel ratio and the rotating speed and the load and the in-cylinder wet information.

The operating conditions of the engine 11 in the first to third embodiments (the air-fuel ratio, rotating speed and load, and in-cylinder wet information) are not limiting. The PM attachment amount may be corrected in response to any operating condition that affects the PM particle size distribution.

The first to third embodiments apply the present disclosure to the system having the PM sensor 33 provided downstream of the GPF 25, but this is not limiting. The present disclosure may be applied to a system having a PM sensor upstream of a GPF and a system having only a PM sensor without a GPF to compute or estimate a PM attachment amount of the PM sensor. In the case, the engine may be controlled to reduce the PM emission amount of the engine based on the computed PM attachment amount (for example, to reduce the in-cylinder wet amount of the engine).

The first to third embodiments apply the present disclosure to the in-cylinder injection gasoline engine, but this is not limiting. The present disclosure is applicable to any engine in which a PM particle size distribution changes in response to an engine operating condition whether the engine is a diesel engine or an intake port injection gasoline engine.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A PM detection device for an internal combustion engine, the apparatus comprising:
a PM sensor outputting a signal in response to a resistance between a plurality of electrodes provided to a detection portion to which a particulate matter emitted from the internal combustion engine are attached; and
a PM detection portion computing a PM attachment amount, which is an amount of a PM attached to the detection portion of the PM sensor, based on an output signal of the PM sensor by using a relation between the output signal of the PM sensor and the PM attachment amount, wherein
the PM detection portion corrects the PM attachment amount in response to an operating condition of the internal combustion engine when computing the PM attachment amount based on the output signal of the PM sensor.

2. The PM detection device for the internal combustion engine according to claim 1, wherein
when computing the PM attachment amount based on the output signal of the PM sensor, the PM detection portion changes the relation between the output signal of the PM sensor and the PM attachment amount in response to the operating condition of the internal combustion engine to correct the PM attachment amount in response to the operating condition of the internal combustion engine.

3. The PM detection device for the internal combustion engine according to claim 1, wherein
the PM detection portion uses an air-fuel ratio of the internal-combustion engine as the operating condition of the internal combustion engine.

4. The PM detection device for the internal combustion engine according to any claim 1, wherein
the PM detection portion uses at least one of a rotating speed or a load of the internal combustion engine as the operating condition of the internal combustion engine.

5. The PM detection device for the internal combustion engine according to claim 1, wherein
the PM detection portion uses a parameter correlating to an in-cylinder wet amount, which is an amount of a fuel attached in a cylinder of the internal combustion engine, as the operating condition of the internal-combustion engine.

6. The PM detection device for the internal combustion engine according to claim 5, wherein
the PM detection portion uses at least one of a cooling water temperature, a fuel injection timing, or a number of injections of split injection that splits the fuel to a plurality of fuel injections in the internal combustion engine, as the parameter correlating to the in-cylinder wet amount.
